(19) United States
(12) Patent Application Publication
(10) Pub. No.: US 2012/0150765 A1
(43) Pub. Date: Jun. 14, 2012

(54) Regional Currency Portfolio And Index

(76) Inventor: Ronald L. Leven, New York, NY (US)

(21) Appl. No.: 12/966,312

(22) Filed: Dec. 13, 2010

(51) Int. Cl. G06Q 40/00

(52) U.S. Cl. 705/36 R; 705/35; 705/37

(57) ABSTRACT

A computerized method involves determining a first currency weighting factor, for a group of countries consisting of individual countries in a region, based upon individual country GDP information relative to total regional GDP information for the group, determining a second currency weighting factor for the individual countries based upon individual country currency liquidity information relative to total regional currency liquidity information for the group, determining a third currency weighting factor for the individual countries based upon implied volatility information for each individual country in the group's currency as a percentage of the sum of the implied volatility information of the group members, wherein the third currency weighting factors are higher for higher volatilities and lower for lower volatilities, and calculating, for each of the individual countries, a currency weight factor as an average of the first, second and third currency weighting factors.

### FIELD OF THE INVENTION

This application generally relates to computerized analysis in the area of international finance and, more particularly, to computerized analysis involving multiple currencies.

### BACKGROUND

There are few ways for investors to access exposure to an emerging region in a liquid way, let alone ways that will allow investors to take a view on the region without having to decide which currency in the region will be an out-performer. To the extent such ways exist, they are generally based upon weightings reflecting market size, market capitalization or economic importance in the region (i.e. trade weights). Moreover, the only known index for the emerging Asia region is the JPMorgan Asia Currency Index (Symbol: ADXY) and that index's composition is based on a weighting of 75% trade weights and 25% liquidity, which is believed to be based upon Choi, A Roadmap for the Asian Exchange Rate Mechanism: A Common Currency Approach, Korea Institute of Finance, FES-2005-07-3 (2005).

### SUMMARY

To address the above problem an approach has been devised that offers investors a liquid way to access exposure to an emerging region that has many illiquid currencies. The approach to setting weights results in a portfolio or index that will generally be more reactive to, and indicative of, changing economic conditions in the specified emerging region.

Our approach can allow investors to take a view on the emerging region (a group of regional country currencies in the emerging region) without having to decide which currency in that region will be the out-performer. Many currencies in emerging regions trade on a non-deliverable forward (NDF) basis. In addition, the approach allows creation of a tradable index that can be settled on a free trading currency basis, for example, the U.S. dollar or the Euro; so it offers the potential additional benefit of being accessible to investors that have difficulty trading currencies on an NDF basis.

In addition, the approach can be used to construct a portfolio or index for commodities for the emerging countries that make up the group or a portfolio of equity indicies for those countries (assuming each such emerging market country has such an index).

One aspect is a computerized method involving determining a first currency weighting factor for a group of countries, consisting of individual countries in a region, based upon individual country GDP information relative to total regional GDP information for the group. determining a second currency weighting factor for the individual countries based upon individual country currency liquidity information relative to total regional currency liquidity information for the group, determining a third currency weighting factor for the individual countries based upon implied volatility information for each individual country in the group's currency as a percentage of the sum of the implied volatility information of the group members, wherein the third currency weighting factors are higher for higher volatilities and lower for lower volatilities, and calculating, for each of the individual countries a currency weight factor as an average of the first currency weighting factor, second currency weighting factor and third currency weighting factor, wherein the currency weight factors for the group collectively defines a currency portfolio for the region.

Another aspect involves a apparatus for generating a regional currency index. The apparatus includes a currency transaction data processing system including at least one processor and storage, the storage including instructions which when executed by the at least one processor will cause the currency transaction data processing system to repeatedly: multiply spot rates for a defined group of currencies of individual countries by currency weight factors for each member of the defined group, the currency weight factors having been previously calculated as an average of at least three factors, wherein one of the at least three factors is volatility and wherein higher volatility country currencies in the defined group are weighted more heavily than lower volatility country currencies in the defined group, to generate current weighted regional currency values for each of the currencies in the defined group, normalize the current weighted regional currency values to obtain normalized regional currency values, and generate the regional currency index as an average of the normalized currency values.

Yet another aspect involves an apparatus having a processor, storage, accessible by the processor, first programming in the storage, executable by the processor, to compute country-specific factors, on an individual country basis based upon at least relative economic size, liquidity and volatility, second programming in the storage, executable by the processor, to compute country-specific weightings, on an individual country basis and store results of the computation as a set of weightings for specific countries, and third programming in the storage, executable by the processor, comprising an index generation module configured to convert the set of weightings for specific currencies and individual spot currency prices for the specific currencies into a regional currency index, publish the regional currency index, and periodically update the regional currency index.

A further aspect involves a computer readable medium having instructions stored thereon. The instructions, when executed by a computing device, cause the computing device to determine a first currency weighting factor for a group of countries in a region based upon individual country GDP information relative to total regional GDP information for the group, determine a second currency weighting factor for the individual countries based upon individual country currency liquidity information relative to total regional currency liquidity information for the group, determine a third currency weighting factor for the individual countries based upon implied volatility information for each individual country in the group's currency as a percentage of the sum of the implied volatility information of the group members such that the third currency weighting factors are higher for higher volatilities and lower for lower volatilities, and calculate a currency weight factor for each of the individual countries as an average of the first, second and third currency weighting factors.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified fashion, example configurations suitable for use with, and containing, an apparatus according to the present claims;

FIG. 2 illustrates, in simplified fashion, an overview of the process of specifying an emerging market region;

FIG. 3 illustrates, in simplified fashion, the general process flow for the “G” factor determination;

FIG. 4 illustrates, in simplified fashion, the general process flow for the “L” factor determination;

FIG. 5 illustrates, in simplified fashion, the general process flow for the “V” factor determination;

FIG. 6 illustrates, in simplified fashion, the general process flow for the optional “IR” factor determination;

FIG. 7 illustrates, in simplified fashion, the general process flow for the overall weighting determination; and

FIG. 8 illustrates, in simplified fashion, a flow diagram for constructing the index.

### DETAILED DESCRIPTION

In simplified overview, the approach constructs a portfolio of emerging market currencies whose weight in the portfolio is based upon at least three factors, relative economic size, liquidity and volatility. Optionally, interest rates can be used as a fourth factor. Additionally, or alternatively, the approach can be used to create an index for the emerging region based upon those factors. Advantageously, the approach also allows creation of financial instruments, including exchange traded funds, exchange traded notes, and various other types of derivative instruments that mirror, or are linked to the performance of, the portfolio or index.

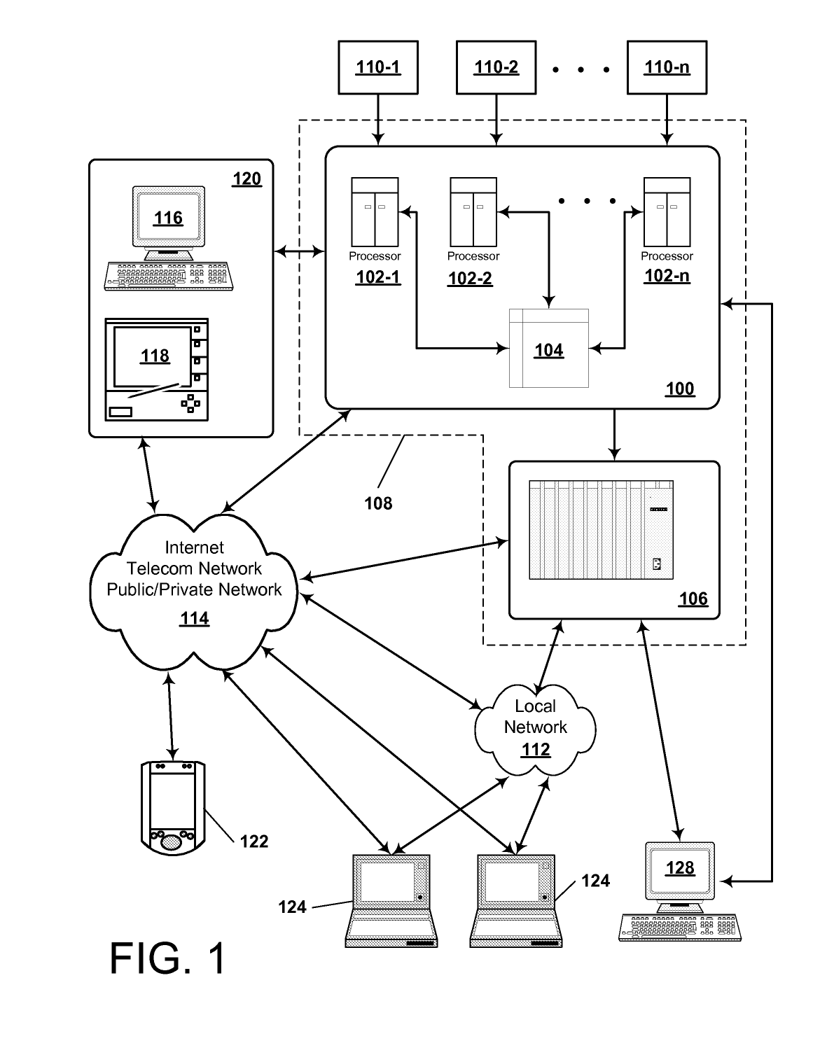

In the above regard, FIG. 1 illustrates, in simplified fashion, example configurations suitable for use with, and containing, an apparatus according to the present claims. Specifically, the approach is implemented as a computerized approach in which a currency analysis processing system (100) is constructed that is made up of at least one, and possibly more, processors (102-1, 102-2, . . . 102-n) and storage (104), accessible by the processor(s) which itself may be made up of various storage devices such as random access memory (“RAM”), read only memory (“ROM”), solid state memory, disk drives, or any other storage device capable of holding data and/or program code to effect the approaches referred to herein.

The currency analysis processing system (100) is configured such that one or more of the processor(s) (102-1, 102-2, . . . 102-n) operating under control of the program code, specifying desired program flow, can receive information and access the storage to implement one or more of the variant approaches described in greater detail herein.

Depending upon the particular variant and implementation, the currency analysis processing system (100) can be coupled to, or optionally itself contain, an exchange system (106) such that the currency analysis processing system (100) alone, or in conjunction with the exchange system (106), will function as a currency transaction data processing system (108). The exchange system (106), if not implemented as part of the currency analysis processing system (100) will itself contain processing and storage capability that can be constructed and used in a conventional way an exchange for financial instruments can be constructed so as to enable it to receive bids and offers for financial instruments and match bids and offers for those financial instruments.

Depending upon the particular variant and implementation, the currency analysis processing system (100) and/or the currency transaction data processing system (108) may also be configured to publish an index, constructed as described herein, for receipt and/or viewing by the relevant audience.

In addition, the currency analysis processing system (100) is configured to receive financial data, using known methods, either directly from the data sources or via third-party sources (110-1, 110-2, . . . , 110-n) such as Bloomberg, Haver Analytics, Thomson, etc. The data can include, for example, data from the Triennial Central Bank Survey of Foreign Exchange and Derivatives Market Activity, data from the International Monetary Fund (“IMF”), currency spot pricing information, and national source or other information regarding the countries and/or currencies of interest.

Depending upon the particular implementation variant and circumstances, the currency analysis processing system (100), the exchange system (106), and/or the currency transaction data processing system (108) can be made accessible to at least one or more of the following via, for example any one or more of, a local network (112) or a more widely accessible network (114) such as the internet, a telecommunications network or some other form of public or private network. In this way, the results of the different variant approaches herein can be made available to, for example, terminals (116) and specialized order entry systems (118) of an exchange or trading floor (120), persons of interest using a wireless handheld device like a smartphone (122), personal computers (124), or to terminals typical for the financial industry (126). Of course, depending upon the particular implementation, a device (128) which could be any of the foregoing types of devices (116, 118, 122, 124) could directly connect to the currency analysis processing system (100), the exchange system (106), and/or the currency transaction data processing system (108), the particular device or mode of connection details being both conventional and unimportant to understanding or use of the variants described herein.

Having described various physical components that can be used to implement or use numerous variant approaches as a backdrop, details about the various variants of the approaches themselves will now be discussed.

As a preliminary point, it should be noted that, as used herein, the term “region” is intended to mean emerging market countries (irrespective of actual geographical location or geographical location relative to any other emerging market country) and “regional currency” is intended to mean currencies of a group of emerging market countries. Depending upon the particular variant, they group will likely be from the same geographical region. However, this need not be the case. For some variants, the region could be a group of emerging market countries from different parts of the world sharing a common interrelating characteristic, for example, high tech products/services of the “BRIC” countries of Brazil, Russia, India and China, or producers/providers or emerging market importers of certain goods or services.

As a non-limiting example, potential candidate emerging market entities (and their currency code) could include any permutation or combination of: Argentina (ARS), Brazil (BRL), China (CNY), Czech Republic (CZK), Hong Kong (HKD), Hungary (HUF), India (INR), Indonesia (IDR), Israel (ILS), Malaysia (MYR), Mexico (MXN), Philippines (PHP), Poland (PLN), Russia (RUB), Singapore (SGD), South Africa (ZAR), South Korea (KRW), Taiwan (TWD), Thailand (THB), and Turkey (TRY), to name a few. Of course other emerging market country currencies with sufficient liquidity could be included in or substituted for the above.

The approach begins with the selection of the constituent emerging market entities which will make up the group (i.e. the emerging market region).

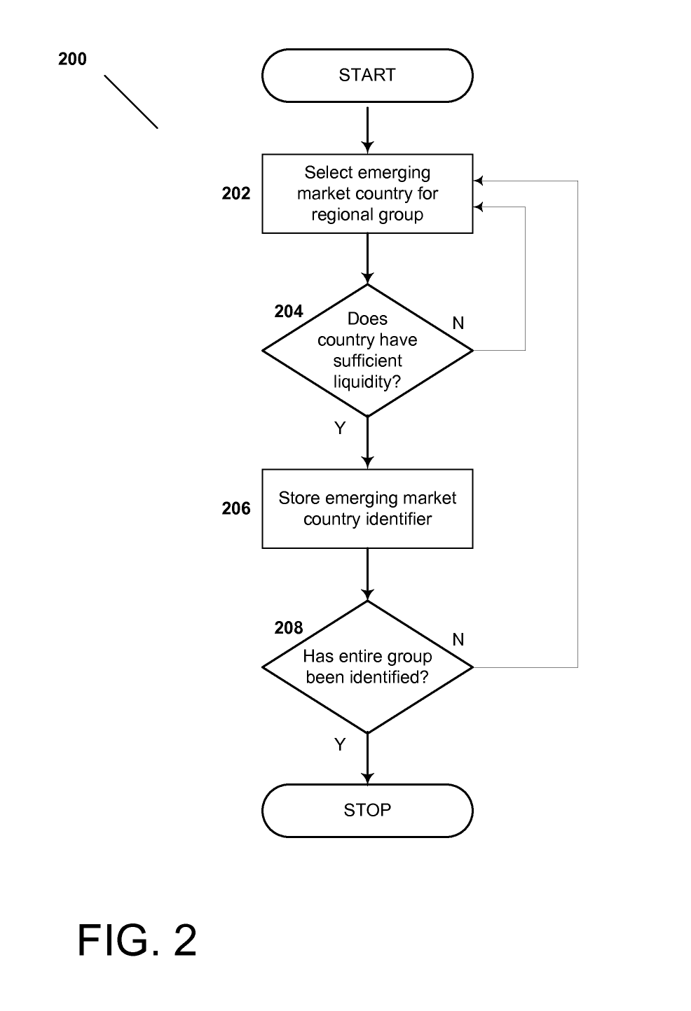

This approach is contained in FIG. 2, which illustrates, in simplified fashion, an overview of the process 200 of specifying an emerging market region. Note that this phase of the process may be omitted if the group is already known to define a region and all of the group member currencies are sufficiently liquid. If not, then, each of countries are specified as potential candidates for the group (Step 202). Since emerging country currencies can change from illiquid to liquid (or vice-versa) over time a check is done to determine if the currency of the selected country is sufficiently liquid (Step 204). If not, it cannot be used and a new candidate must be selected (Step 202). If so, an identifier for that country is stored in the storage (Step 206). Then, if the entire group has not yet been identified (according to the intent of the user) (Step 208) the process repeats (Step 202). If the entire group has been identified, this phase of the process is complete.

For purposes of example illustration, emerging countries in Asia will be used. Note that there are many currencies in emerging Asia (i.e. Asia excluding Japan) that do not have adequate liquidity in offshore markets to be practical for inclusion in a group at this time. Thus, for purposes of example, the Asian countries and currencies to make up the group are: China (yuan (CNY)), South Korea, (won (KRW)), Hong Kong (dollar (HKD)), Malaysia (ringgit (MYR)), India (rupee (INR)), the Philippines (peso (PHP)), Indonesia (rupiah (IDR)), Singapore (dollar (SGD)), and Taiwan (dollar (TWD)). Note that Thailand is one of the more important economies in the region and could have been included in the group. However, for purposes of example, the offshore liquidity of the That baht (THB) is considered not currently adequate for its inclusion. Thus, it is to be recognized that the approach is flexible such that a currency of a country like the THB can be added at some point if liquidity improves. Conversely, if liquidity of a particular country currency becomes a problem, that entity can easily be removed from the group by treating the remaining members as a new group and recalculating as described herein.

### Determining the Weights

As noted above, the approach uses at least three factors in creating the weights: relative economic size (The “G” Factor), liquidity (The “L” Factor) and volatility (The “V” Factor). Optionally, interest rates (The “IR” Factor) can be used as an additional factor.

In determining the weights, it should be noted that each basic weight determination (G, L, V (and optional IR) is independent of the others. As a result, they can be determined sequentially, concurrently, partially overlapping, by different physical processors (which would then collectively constitute “a processor”), in any order, etc. Those details are wholly unimportant to the invention. Rather, the only important aspect regarding timing of the determinations is that all of the factors to be used must be available to combine them into the weight factor “W” described below.

### Relative Economic Size (the “G” Factor)

Since the approach is intended to reflect general economic conditions in the region, one weighting factor is economic size of the region components relative to the group of countries defining the region. The approach uses GDP information for economic size. However, depending upon the particular variant, other measures if there is sufficient appropriate available information (direct or derived) can be used, as can a different time period. In addition, it should be understood that since the sum of that information is also used, it can be determined, either as each individual country's information is obtained (a running total) or after all have been obtained. The particular process used to obtain the total is irrelevant to the invention.

The weight (G) that represents relative economic size for each country i is calculated according to Equation (1) as:

Gᵢ=GDPᵢ/GDP_{TOTAL} (1)

where, for n total countries, GDP_{TOTAL} is the sum of G₁+G₂+ . . . +Gₙ

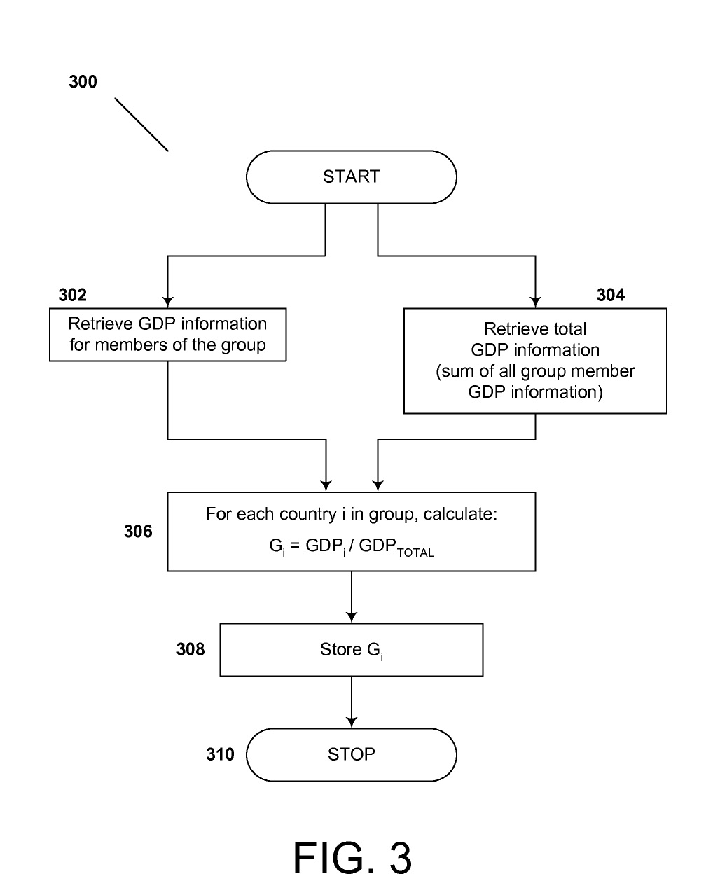

The general process flow for this calculation is shown in FIG. 3. The process 300 begins with the retrieval of the GDP information for a country and the sum of the GDP information for all of the members of the group (Step 302, Step 304). To reflect the above-mentioned order independence, the retrievals are shown in parallel. Next, the weight G for each country i is calculated according to Equation (1) above (Step 306). Then the weights are stored (Step 308). When all the weights G for all the countries i are stored, this phase is complete (Step 310).

### Liquidity (the “L” Factor)

Another weighting factor is based upon liquidity of each country currency. It should again be understood that since the sum of that information is also used, it can be determined, either as each individual country's information is obtained (a running total) or after all have been obtained. The particular process used to obtain the total is irrelevant to the invention.

Depending upon the particular variant, liquidity can be determined as a reflection of the relative volume of turnover in the region or, in a known manner, based upon bid/asked spreads using an approach similar to relative economic size according to Equation (2) as:

Lᵢ=Lᵢ/L_{TOTAL} (2)

where, for n total countries, L_{TOTAL} is the sum of L₁+L₂+ . . . +Lₙ

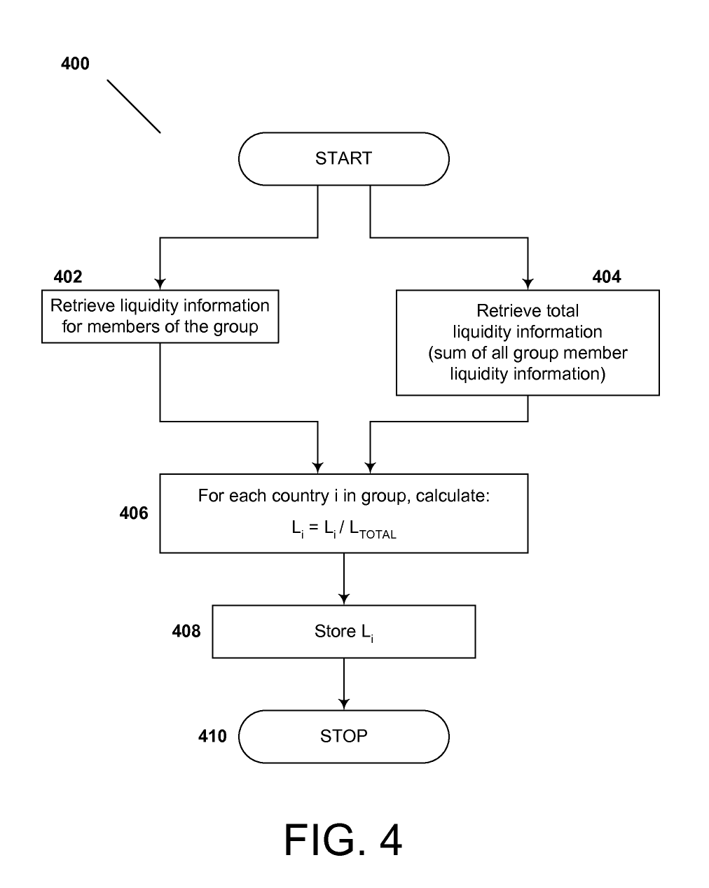

The general process flow for this calculation is shown in FIG. 4. The process 400 begins with the retrieval of the liquidity information for a country and the sum of the liquidity information for all of the members of the group (Step 402, Step 404). Again, to reflect the above-mentioned order independence, the retrievals are shown in parallel. Next, the weight L for each country i is calculated according to Equation (2) above (Step 406). Then the weights are stored (Step 408). When all the weights L for all the countries i are stored, this phase is complete (Step 410).

### Volatility (the “V” Factor)

The third weighting factor is based upon volatility. Here too, it should be understood that since the sum of that information is also used, it can be determined, either as each individual country's information is obtained (a running total) or after all have been obtained. The particular process used to obtain the total is irrelevant to the invention.

This approach measures volatility using the average 3 month option-implied volatility over some specified period, for example, the past five years. In addition, and in contrast to what conventional thinking would suggest, the approach herein gives bigger weight to currencies with higher volatility. Conventional thinking would tend to de-weight the more volatile currencies out of the belief that large and/or high frequency swings would add more overall instability to a portfolio or index. The rationale used in the approach herein is that movements of many emerging market country currencies are heavily controlled/pegged, so the focus is on more freely trading currencies as proxies for general regional performance.

The volatility is calculated using, for example, the average mid-market daily 3 month implied volatility for the prior year. Other measures of implied volatility can also be used provided the information is available for each currency of concern. Such information is available from numerous sources including, for example Bloomberg. If Bloomberg is the source, that information can be obtained under code “xxxV3M, <Curncy> where xxx would be replaced by the particular currency indicator (e.g. CNY, KRW, INR, etc.) for which the information is sought. That information is converted to a percentage relative to the other members of the group in a manner similar to the above, according to Equation (3) as:

Vᵢ=Vᵢ/V_{TOTAL} (3)

where, for n total countries, V_{TOTAL} is the sum of V₁+V₂+ . . . +Vₙ

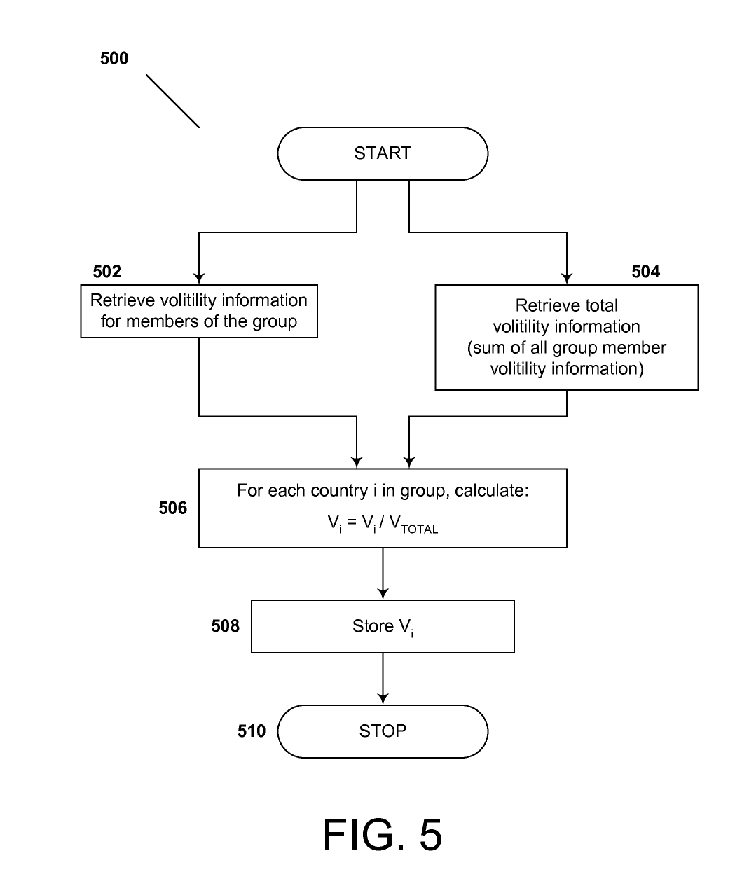

The general process flow for this calculation is shown in FIG. 5. The process 500 begins with the retrieval of the volatility information for a country and the sum of the volatility information for all of the members of the group (Step 502, Step 504). Again, to reflect the above-mentioned order independence, the retrievals are shown in parallel. Next, the weight V for each country i is calculated according to Equation (3) above (Step 506). Then the weights are stored (Step 508). When all the weights V for all the countries i are stored, this phase is complete (Step 510).

### Interest Rates (the “IR” Factor) (Optional)

Optionally, a fourth factor, interest rates, can be included. Yet again, it should be understood that since the sum of that information is also used, it can be determined, either as each individual country's information is obtained (a running total) or after all have been obtained. The particular process used to obtain the total is irrelevant to the invention.

As a proxy for carry, carry being a key factor in general interest in emerging market currencies, an average of yield for some past time-period is used, for example, the one year yield. For deliverable currencies, assuming a fairly recent time period will be used, interest rates are reflected by using the one year on-shore deposit rate as the proxy for yield. For non-deliverable forward (“NDF”) currencies the one year yield implied by the off-shore forward rate. (Note that in some cases, the NDF implied rate will be negative). Alternatively, for NDF currencies, implied interest rates that are biased towards those currencies with the highest interest rates can be used. Where interest rate is to be taken into account as a factor, their weighting is calculated, similar to the above, according to Equation (4) as:

IRᵢ=IRᵢ/IR_{TOTAL} (4)

where, for n total countries, IR_{TOTAL} is the sum of IR₁+IR₂+ . . . +IRₙ

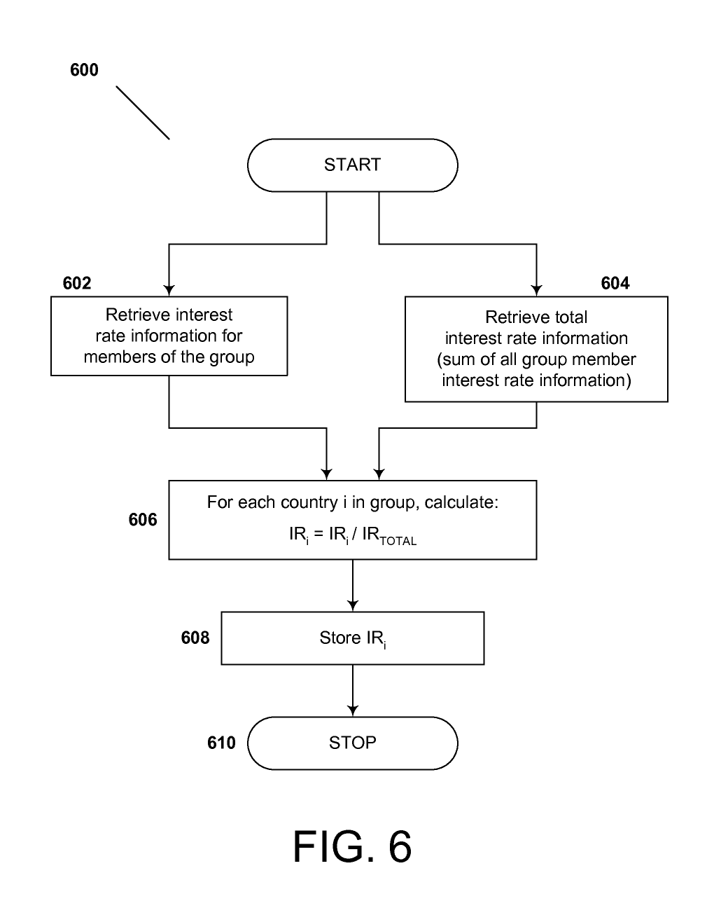

The general process flow for this calculation is shown in FIG. 6. The process begins with the retrieval of the interest rate information for a country and the sum of the interest rate information for all of the members of the group (Step 602, Step 604). Again, to reflect the order independence, the retrievals are shown in parallel. Next, the weight IR for each country i is calculated according to Equation (4) above (Step 606). Then the weights are stored (Step 608). When all the weights IR for all the countries i are stored, this phase is complete (Step 610).

### Optional Adjustments

### Covariance (Optional)

Depending upon the particular implementation, it is possible that two or more members of a group can be highly covariant. Thus, it may be desirable for some variants of the approach to determine whether there is an excess covariance relationship between two or more members of the group, and if so, its level. In such a case, covariance all pairs of currencies in the group is calculated using any of numerous known mathematical covariance calculation approaches. In some cases, the existence of a high covariance may be empirically known. In either case, if desired, an adjustment is performed for all currencies where the covariance is in excess of a specified value or is empirically known to be high. Depending upon the particular case, the specified value will generally be a covariance in excess of about 60%, and typically in excess of about 65%. In such a case, it is desirable to de-weight the lower weighted covariant country's weights by some factor which can typically range from about 20% to about 50%. For purposes of illustrative example, using the Asian currencies noted above, it is determined that the CNY and HKD are highly covariant, either through covariance calculations due to the known fact that both are tightly linked to the U.S. dollar. As a result, employing this option, the weights for the HKD are cut in half (i.e. by 50%) to reduce this influence. Alternatively, the values used to determine the factors for the HKD can be halved before doing the calculation, the way the math is carried out is unimportant.

In another illustrative example, because the HKD and SGD are offshore trading centers, the Triennial Central Bank Survey of Foreign Exchange and Derivatives Market Activity turnover data is much higher than for other countries. To offset this bias, the weightings for these two countries can be reduced, for example, cut in half. Alternatively, the values used to determine the factors for those currencies could be halved before doing the calculation, the way the math is carried out is unimportant.

In addition, depending upon the particular implementation variant, the de-weighted percentage can simply be discarded, it can be equally distributed among the other members of the group (which may or may not include the member(s) of the group with which the high covariance exists) or it can be proportionally distributed (direct or inversely) among the other members of the group (which also may or may not include the member(s) of the group with which the high covariance exists).

Weight Cap (Optional)

Also, with some variants, in order to prevent any single currency from dominating the others in the group, it may be desirable to cap the weights at some value. Typically, that value would be about 20% for a smaller group of countries and 10% for a larger group, although it could be more or less depending, for example, on the number of members of the group and their respective weightings. If the weighting of any member exceeds the cap, the excess can be dealt with in any of the ways described in connection with de-weighting, i.e., simply discarded, equally distributed among the other members of the group or proportionally distributed (direct or inversely) among the other members of the group.

### Portfolio or Index Determination

Once the individual weights G, L, V (and optional IR) for each of the members of the group have been determined, the overall weightings for each of the members of the group is calculated as the average of those weights according to Equation (5) or Equation (6) (depending upon whether the optional interest rate factor is used) as:

Wᵢ=(Gᵢ+Lᵢ+Vᵢ)/3 or (5)

Wᵢ=(Gᵢ+Lᵢ+Vᵢ+IRᵢ)/4 (6)

where i is the particular country and the calculation is done for countries i=1, 2, . . . , n.

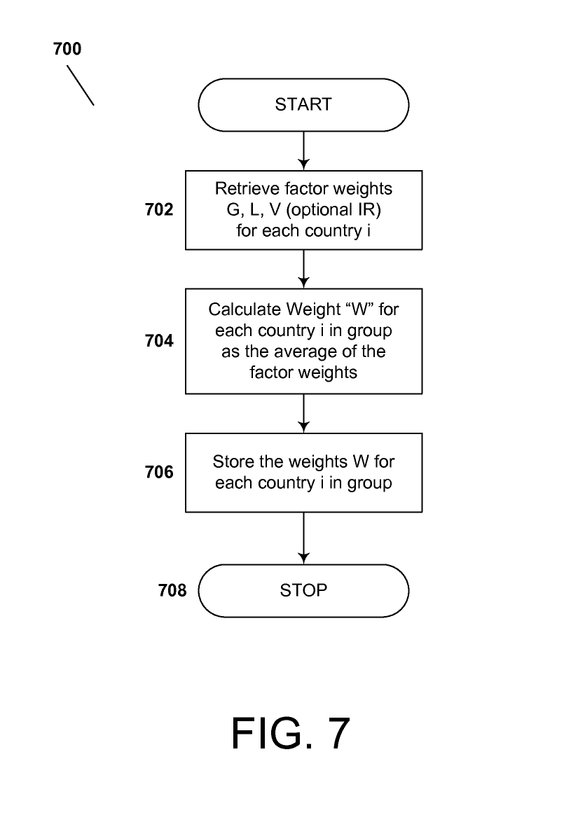

FIG. 7 illustrates, in simplified fashion, the general process flow 700 for the overall weighting determination. First, the weights G, L, V and optionally IR are retrieved from storage (Step 702). Then the weight W is calculated for each as described above (Step 704). Those weights W are then stored (Step 706) and the process is complete (Step 708).

The resulting values Wᵢ through Wₙ will thereby define a portfolio of currencies that, according to the specified percentages, allows an investor to take a view on the emerging country region as a whole (i.e. the group), without having to decide which of the members of the group will be an out-performer.

Table 1 below shows the results of constructing a portfolio according to the above methods for a group of currencies made up of nine Asian emerging country currencies noted above and that does not include the optional interest rate factor.

TABLE 1

| | | | | | Liq.ᵢ/ | | |
|---|---|---|---|---|---|---|---|
| | | | Implied | GDPᵢ/GDP_{TOTAL} | Liq._{TOTAL} | Vol.ᵢ/Vol_{TOTAL} | |
| i | GDP | Liquidity | Volatility | (Gᵢ) | (Lᵢ) | (Vᵢ) | Wᵢ |
| CNY | 3502 | 7 | 2.00% | 52.80% | 3.20% | 2.70% | 19.60% |
| HKD | 100 | 37 | 0.30% | 1.50% | 16.20% | 0.40% | 6.00% |
| INR | 1110 | 30 | 10.90% | 16.70% | 13.00% | 14.90% | 14.90% |
| IDR | 427 | 17 | 14.00% | 6.40% | 7.40% | 19.10% | 11.00% |
| KRW | 922 | 26 | 14.50% | 13.90% | 11.30% | 19.70% | 15.00% |
| MYR | 179 | 0 | 8.30% | 2.70% | 0.00% | 11.30% | 4.70% |
| PHP | 138 | 31 | 9.50% | 2.10% | 13.30% | 13.00% | 9.40% |
| SGD | 160 | 70 | 6.80% | 2.40% | 30.30% | 9.20% | 14.00% |
| TWD | 101 | 12 | 7.10% | 1.50% | 5.40% | 9.70% | 5.50% |
| | 6639 | 230 | 73.40% | 100.00% | 100.00% | 100.00% | 100.00% |

As can be seen, the first column identifies each of the country i currencies. The second column identifies the “G” factor in terms of GDP of each country, denominated in billions of U.S. dollars, as described above. For purposes of the example, this is proxied for the Asian countries noted above using cumulative U.S. dollar valued nominal GDP over the past five years. The third column identifies the “L” factor in terms of liquidity for each, denominated in billions of U.S. dollars, as described above. For purposes of this illustrative example, the liquidity is determined by the turnover as reported in the 2007 Triennial Central Bank Survey of Foreign Exchange and Derivatives Market Activity (December 2007). The fourth column identifies “V” factor in terms of the implied volatility percentage for each. The bottom row of those columns is the sum of each column and thereby respectively represents the total GDP, liquidity and implied volatility for the group. The fifth, sixth and seventh columns respectively contain the individual country weights, calculated as the value in each of the second, third and fourth columns divided by the total for the respective column as noted above. The eighth column contains the resulting weights Wᵢ calculated using the G, L and V factors as described above, with the portfolio being defined by the respective weight percentages for each assuming that no further optional adjustments will be made.

Table 2 below shows the results of constructing another example portfolio according to the above methods for the group of currencies from Table 1 that is based upon turnover as reported in the 2010 Triennial Central Bank Survey of Foreign Exchange and Derivatives Market Activity, Preliminary Results (April 2010) instead of turnover as reported in the 2007 Triennial Central Bank Survey of Foreign Exchange and Derivatives Market Activity (December 2007) and does not include the optional interest rate factor.

Note that, for this portfolio, the volatility look back time period has been changed to 3 years to make it more stable. Moreover, as a result of using the 2010 turnover data, there was a sharp rise in the liquidity and volatility factors for both the KRW and CNY, causing the overall weight for the CNY to exceed the optional 20% cap specified for this portfolio. As a result, the excess weighting for the CNY was proportionally allocated across the other currencies. Note that the columns do not always add to 100% due to rounding.

TABLE 2

| | GDPᵢ/GDP_{TOTAL} | Liq.ᵢ/Liq._{TOTAL} | | |
|---|---|---|---|---|
| i | (Gᵢ) | (Lᵢ) | Vol.ᵢVol_{TOTAL} (Vᵢ) | Wᵢ |
| CNY | 52.80% | 6.7% | 3.3% | 21.2% |
| HKD | 1.50% | 22.6% | 0.3% | 8.1% |
| INR | 16.70% | 9.8% | 13.6% | 13.3% |
| IDR | 6.40% | 2.2% | 21.3% | 10.0% |
| KRW | 13.90% | 21.5% | 23.8% | 19.6% |
| MYR | 2.70% | 2.7% | 9.0% | 4.8% |
| PHP | 2.10% | 1.3% | 11.8% | 5.1% |
| SGD | 2.40% | 25.5% | 8.6% | 12.2% |
| TWD | 1.50% | 7.6% | 8.2% | 5.8% |
| | 100% | 99.9% | 99.9% | 100.1% |

Table 3 below shows the results of constructing a further alternative example portfolio according to the above methods for a group of currencies made up of emerging country currencies from different geographic regions that includes the optional interest rate factor. Note that each of the columns have been rounded to whole numbers (or one decimal place for the weights) for simplicity, so some of the columns may not add to exactly 100%.

TABLE 3

| | | | Implied | Interest | |
|---|---|---|---|---|---|
| i | GDP | Liquidity | Volatility | Rate | Wᵢ |
| CNY | 31% | 4% | 1% | −2% | 8.4% |
| HKD | 1% | 13% | 0% | 1% | 4% |
| INR | 4% | 1% | 4% | 10% | 4.3% |
| IDR | 9% | 6% | 4% | 5% | 6% |
| KRW | 7% | 12% | 7% | 3% | 7.2% |
| MYR | 1% | 2% | 4% | 4% | 2.9% |
| PHP | 1% | 1% | 4% | 6% | 2.9% |
| SGD | 1% | 7% | 3% | 1% | 3.2% |
| TWD | 3% | 4% | 2% | −3% | 1.6% |
| BRL | 11% | 5% | 8% | 14% | 9.6% |
| MXN | 7% | 13% | 6% | 8% | 8.6% |
| CZK | 1% | 3% | 8% | 2% | 3.7% |
| HUF | 1% | 1% | 10% | 8% | 5.2% |
| PLN | 3% | 7% | 12% | 7% | 7.1% |
| RUB | 10% | 7% | 5% | 8% | 7.7% |
| ILS | 1% | 2% | 5% | 3% | 2.8% |
| TRY | 5% | 3% | 8% | 13% | 6.7% |
| ZAR | 2% | 9% | 10% | 12% | 8.2% |

As can be seen, the first column identifies each of the country i currencies. The second column identifies the “G” factor in terms of GDP of each country as described above. The third column identifies the “L” factor as described above. For purposes of this illustrative example, the liquidity is determined by the turnover as reported in the 2010 Triennial Central Bank Survey of Foreign Exchange and Derivatives Market Activity, Preliminary Results (April 2010). The fourth column identifies “V” factor in terms of the implied volatility percentage for each. The fifth column identifies the “IR” factor for each. The sixth column contains the resulting weights Wᵢ calculated using the G, L, V and IR factors as described above, with the portfolio being defined by the respective weight percentages for each assuming that no further adjustments will be made.

Advantageously as a result, once the portfolio is defined, additional steps can be taken. For example, an investor or institution can build a portfolio of the currencies according to the resultant weightings. Hedging strategies can be employed involving, or relative to, the portfolio using known techniques. Alternatively, the portfolio can be part of, or form, a managed account. Still further, financial instruments, including exchange traded funds, exchange traded notes, and various other types of derivative instruments can be constructed in a known manner to mirror, or that are linked to the performance of, the portfolio.

At this point it should also be noted that, in some cases, the weighting of a given currency in a group could be so small as to potentially only be capable of having a negligible effect on the group as a whole. In such a case, that currency could optionally be deemed a “nominal” currency. In general, a nominal currency will have a total weight W on the order of about 3% or less, and typically a weight of less than 1%. In such a case, depending upon the particular implementation, the nominal currency can be dropped by either distributing its weight among the other currencies (equally or proportionately) or, if a covariance analysis is performed, its percentage can be added into the currency with which it has the highest covariance. Of course, it can also be retained if desired.

Advantageously moreover, the approach can further be used to construct an index that will be representative of that emerging country group as a whole.

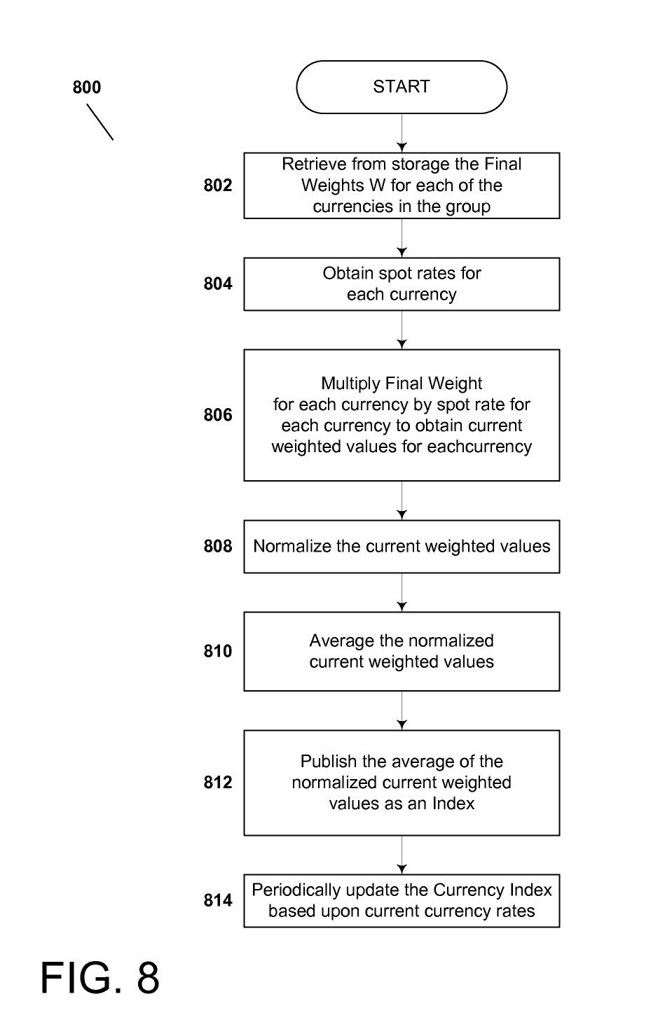

FIG. 8 illustrates, in simplified fashion, a flow diagram (800) for constructing the index. The process begins with retrieval of the final weights W for each of the members of the group (i.e. the resultant values from the process of FIG. 7) (Step 802). Next, spot rates are obtained for each of the currencies in the group (Step 804), for example, directly from a currency exchange or indirectly via a third party provider. Note that, as used herein, the “spot” rate is intended to encompass not only the then-actual instantaneous exchange value, but could alternatively be a forward price, an average price for a specified time period or some other price. In general, the prices will be continually available spot prices. However, to the extent that a given currency price is only quoted on longer time period basis, i.e. hourly, a few times a day, daily, weekly, etc., unless a historical calculation is being performed, the most recent price for each should be used. Next, the final weight for each currency in the group is multiplied by its corresponding spot rate (Step 806).

Each value obtained by multiplying the weight and price are then normalized to a common base (Step 808). There are numerous known approaches in mathematics and economics to accomplish this and the particular computation method will depend upon whether a return index, an absolute performance index or spot index is the intended end result. One simple example illustrative way is to establish a base date and calculate the percentage deviation between the date of concern and the base date. Another way is to treat the base date value for all of the members of the group as a fixed number, for example “100”, and scale everything subsequently by dividing the value on the date of concern by the value on the base date. For example, on the base date, if the value of one of the currencies in the group is 1.5 and the value of another of the currencies in the group is 1350, the base value of 100 would be obtained, for the first currency by multiplying it by 66.6667, and for the second currency by multiplying it by 0.0740. Thus, if on a subsequent date one currency is now 1.375 and another currency is 1500, their respective values for calculating the index would be calculated as (1.375×66.6667)=91.6667 and (1500×0.740)=111.1111.

The regional index is then the arithmetic average of the normalized values (Step 810).

At this point, the index can be “published” (i.e. disseminated for viewing and/or use by the relevant public) (Step 812). Depending upon the particular variant, the index will thereafter be updated, on some periodic basis (Step 814) based upon the then-current rates for the currencies in the group, which could occur, for example, on a continuous basis (i.e. whenever any value changes) like the major equity indicies, it could be updated on a specific scheduled basis, such as every minute or hourly. It could be updated daily, like the Net Asset Valuation (NAV) calculations for mutual funds, or according to some other appropriate chosen scheme.

Again, once an index is created, financial instruments can be created that are based upon, or linked to the performance of, the index in a known manner.

### Other Variants

Finally, it should be appreciated that the above approach could similarly be used to construct a portfolio of commodities for the countries of the group or a portfolio of equity indicies if each of the countries in the group has such an equity index. In such a case, liquidity would reflect turnover or bid/asked spread for the commodity(ies) or indicies at issue and volatility would reflect volatility of each such commodity or index. As a result, “currency” as used herein should be understood to encompass commodities of an emerging market country and an equity index of an emerging market country.

It should be understood that this description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

What is claimed is:

1. A computerized method comprising:
determining, using a processor, a first currency weighting factor for a group of countries, consisting of individual countries in a region, based upon individual country GDP information obtained from storage associated with the processor, relative to total regional GDP information for the group;
determining, using the processor, a second currency weighting factor for the individual countries based upon individual country currency liquidity information obtained from the storage, relative to total regional currency liquidity information for the group;
determining, using the processor, a third currency weighting factor for the individual countries based upon implied volatility information for each individual country in the group's currency as a percentage of the sum of the implied volatility information of the group members, wherein the third currency weighting factors are higher for higher volatilities and lower for lower volatilities; and
calculating, for each of the individual countries using the processor, a currency weight factor as an average of the first currency weighting factor, second currency weighting factor and third currency weighting factor;
wherein the currency weight factors for the group collectively defines a currency portfolio for the region.

2. The method of claim 1, further comprising:
selecting as a member of the group at least two countries, at least one of which is selected from among Argentina, Brazil, China, Czech Republic, Hong Kong, Hungary, India, Indonesia, Israel, Malaysia, Mexico, Philippines, Poland, Russia, Singapore, South Africa, South Korea, Taiwan, Thailand, or Turkey.

3. The computerized method of claim 1, further comprising:
normalizing the currency weight factors for each individual country in the group; and
averaging the normalized currency weight factors,
wherein the average of the normalized currency factors is the regional currency index.

4. The method of claim 1, further comprising:
selecting a set of Asian countries as the group.

5. The method of claim 4, wherein the selecting comprises:
selecting China, Korea, Hong Kong, Malaysia, India, Philippines, Indonesia, Singapore and Taiwan as the set of Asian countries.

6. The method of claim 5, wherein the selecting further comprises:
selecting Thailand as an additional country in the set of Asian countries.

7. The method of claim 3, further comprising:
creating a financial instrument linked to performance of the regional currency index.

8. The method of claim 3, further comprising:
creating a financial instrument having a composition that substantially corresponds to a composition of the regional currency index.

9. The method of claim 3, further comprising:
publishing the regional currency index.

10. The method of claim 3, further comprising:
using the regional currency index as a benchmark for currency investment.

11. The method of claim 1, wherein the individual country currency liquidity information is based upon currency turnover.

12. The method of claim 1, wherein the individual country currency liquidity information is based upon bid and asked spreads.

13. The method of claim 1, further comprising:
covariance adjusting the currency weight factor for at least one member of the group.

14. The method of claim 1, further comprising:
determining a fourth currency weighting factor for individual countries in the group based upon non-deliverable, forward implied interest rates for each individual country as a percentage of the sum of the non-deliverable, forward implied interest rates of the group members; and
wherein the calculating the currency weight factor comprises the averaging the first currency weighting factor, the second currency weighting factor, the third currency weighting factor and the fourth currency weighting factor.

15. An apparatus for generating a regional currency index, the apparatus comprising:
a currency transaction data processing system including at least one processor and storage, accessible by the processor, the storage including instructions which when executed by the at least one processor will cause the currency transaction data processing system to repeatedly:
multiply spot rates for a defined group of currencies of individual countries by currency weight factors for each member of the defined group, the currency weight factors having been obtained from the storage and having been previously calculated as an average of at least three factors, wherein one of the at least three factors is volatility and wherein higher volatility country currencies in the defined group are weighted more heavily than lower volatility country currencies in the defined group, to generate current weighted regional currency values for each of the currencies in the defined group;
normalize the current weighted regional currency values to obtain normalized regional currency values; and
generate the regional currency index as an average of the normalized currency values.

16. The apparatus of claim 15, wherein:
the currency weight factors obtained from the storage resulted from analysis performed in the currency transaction data processing system which calculated a weighted combination of information indicative of relative economic size of each of the members of the group relative to the group as a whole and liquidity information indicative of currency turnover of each of the members of the group relative to the group as a whole.

17. The apparatus of claim 15, wherein the currency transaction data processing system further comprises:
an exchange system configured to
i) receive bids and offers for a financial instrument linked to the regional currency index; and
ii) match the received bids and offers for the financial instrument.

18. An apparatus comprising:
a processor;
storage, accessible by the processor;
first programming in the storage, executable by the processor, to compute country-specific factors, on an individual country basis based upon at least relative economic size, liquidity and volatility;
second programming in the storage, executable by the processor, to compute country-specific weightings, on an individual country basis and store results of the computation as a set of weightings for specific countries; and
third programming in the storage, executable by the processor, comprising an index generation module configured to convert the set of weightings for specific currencies and individual spot currency prices for the specific currencies into a regional currency index, publish the regional currency index, and periodically update the regional currency index.

19. The apparatus of claim 18, further comprising:
an exchange system configured to
receive bids and offers for a financial instrument linked to the regional currency index and match the received bids and offers for the financial instrument.

20. A computer readable medium having instructions stored thereon which, when executed by a computing device, cause the computing device to:
determine a first currency weighting factor for a group of countries in a region based upon individual country GDP information relative to total regional GDP information for the group;
determine a second currency weighting factor for the individual countries based upon individual country currency liquidity information relative to total regional currency liquidity information for the group;
determine a third currency weighting factor for the individual countries based upon implied volatility information for each individual country in the group's currency as a percentage of the sum of the implied volatility information of the group members such that the third currency weighting factors are higher for higher volatilities and lower for lower volatilities; and
calculate a currency weight factor for each of the individual countries as an average of the first currency weighting factor, second currency weighting factor and third currency weighting factor.
